(19) United States
(12) Patent Application Publication
(10) Pub. No.: US 2017/0322834 A1
(43) Pub. Date: Nov. 9, 2017

(54) COMPUTE INSTANCE WORKLOAD MONITORING AND PLACEMENT

(71) Applicant: INTERNATIONAL BUSINESS MACHINES CORPORATION, ARMONK, NY (US)

(72) Inventors: Rafael P. de Sene, Campinas (BR); Rafael C. S. Folco, Santa Barbara d'Oeste (BR); Breno H. Leitão, Campinas (BR); Ricardo M. Matinata, Campinas (BR)

(21) Appl. No.: 15/145,072

(22) Filed: May 3, 2016

(51) Int. Cl. G06F 9/50; H04L 12/26; G06F 9/455; H04L 12/911

(52) U.S. Cl. CPC G06F 9/5083; G06F 9/5077; H04L 43/08; H04L 43/04; G06F 9/45558; H04L 47/822; G06F 2009/4557; G06F 2009/45595

(57) ABSTRACT

Embodiments of the present invention disclose a method, computer program product, and system for a method for a system for deploying compute instances for processing a workload. Receiving a workload to be processed by a computer and determining an architecture for a compute instance that is required to process the workload, wherein the compute instance is an instance of computer system being spawned from a computing device. Setting growth rules for the compute instance, wherein the growth rules determines when the number of compute instances needs to be increased or decreased and deploying the compute instance to process the workload. The computer monitors a demand for the deployed compute instance to process the workload and automatically increasing or decreasing the number of deployed compute instances, based on the monitored demand for the deployed compute instances and the growth rules for the compute instances.

### BACKGROUND

The present invention relates generally to the field of a data processing system or data processing method and more particularly to means apportioning resources to one or more computers or virtual machines on a network to process a workload.

Currently, there are some technologies used to deploy virtual machines that usually have one application in a virtual machines environment. For example, in Linux virtual machines the most common technology is DOCKER, which supports a descriptive language focused on creating a single virtual machine. However, the current method of deploying virtual machines to address the needs of a workload are not able to adapt to a complex workload requiring multiple architectures for the virtual machines and a changing workload.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for a method for a system for deploying compute instances for processing a workload. Receiving a workload to be processed by a computer and determining an architecture for a compute instance that is required to process the workload, wherein the compute instance is an instance of computer system being spawned from a computing device. Setting growth rules for the compute instance, wherein the growth rules determines when the number of compute instances needs to be increased or decreased and deploying the compute instance to process the workload. The computer monitors a demand for the deployed compute instance to process the workload and automatically increasing or decreasing the number of deployed compute instances, based on the monitored demand for the deployed compute instances and the growth rules for the compute instances.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating a system for deploying compute instances, in accordance with an embodiment of the present invention.

FIG. 2 illustrates the deployed compute instances, in accordance with an embodiment of the present invention.

FIG. 3 is a flowchart depicting operational steps of deploying and monitoring the compute instances within the system for deploying compute instances of FIG. 1, in accordance with an embodiment of the present invention.

FIG. 4 is a block diagram of components of a computing device of the system for deploying compute instances of FIG. 1, in accordance with embodiments of the present invention.

FIG. 5 depicts a cloud computing environment according to an embodiment of the present invention.

FIG. 6 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for automatically deploying and recalling virtual machines. The system deploys virtual machines to handle a workload. The demand for the workload can vary over time, meaning that the demand for the workload can either increase or decrease over time. The system increases the number of virtual machines if the workload demand is greater than a threshold value in accordance with the placement criteria of the virtual machine. The system decreases the number of virtual machines if the workload demand is less than a threshold value in accordance with the placement criteria of the virtual machine.

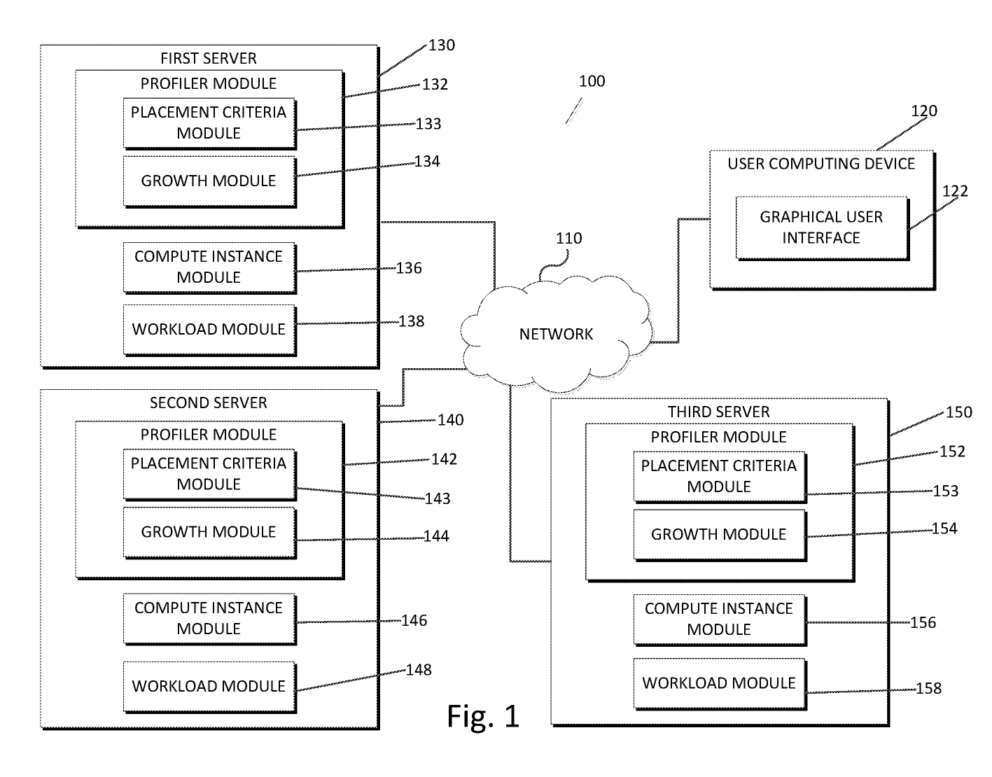

FIG. 1 is a functional block diagram illustrating a system for deploying compute instances for processing a workload 100, in accordance with an embodiment of the present invention. The system for deploying virtual machines for processing a workload 100 includes a user computing device 120, a first server 130, a second server 140, and a third server 150, communicating via network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between the user computing device 120, the first server 130, the second server 140, and the third server 150, in accordance with one or more embodiments of the invention.

The user computing device 120 represents a computing device that includes a user interface, for example, a graphical user interface (GUI) 122 that allows the user to upload financial data to server 130. GUI 122 represents one or more user interfaces for sending and receiving information from the server 130. GUI 122 may be, for example, a web browser, an application, or other types of GUIs for communication between the user computing device 120, the first server 130, the second server 140, and the third server 150, via the network 110.

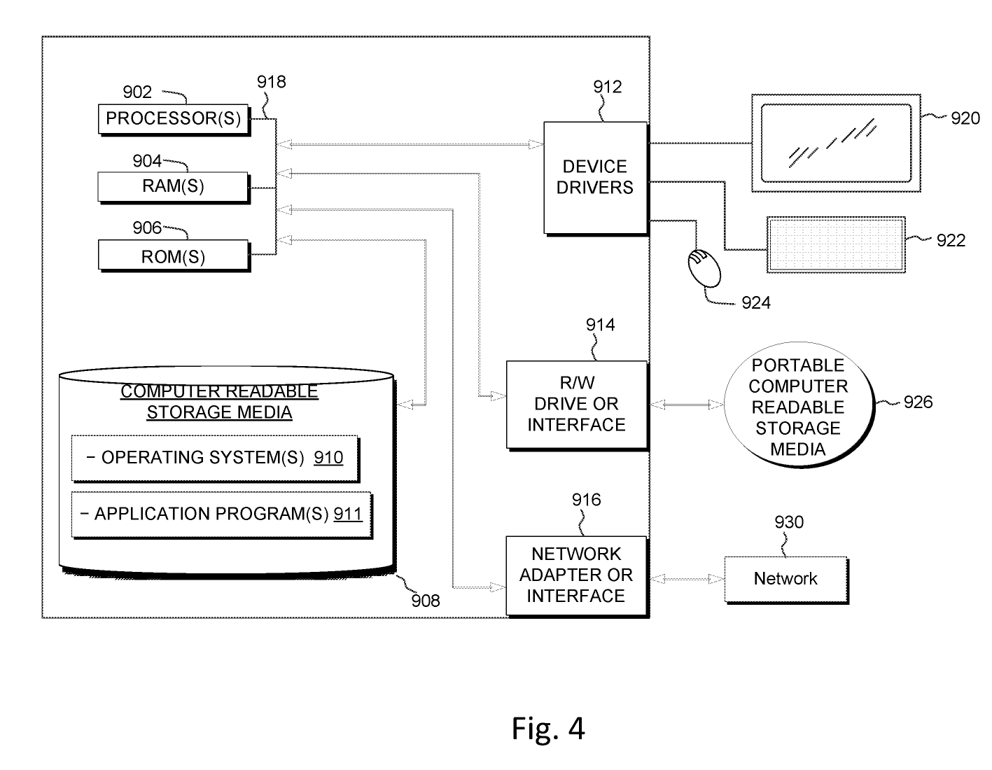

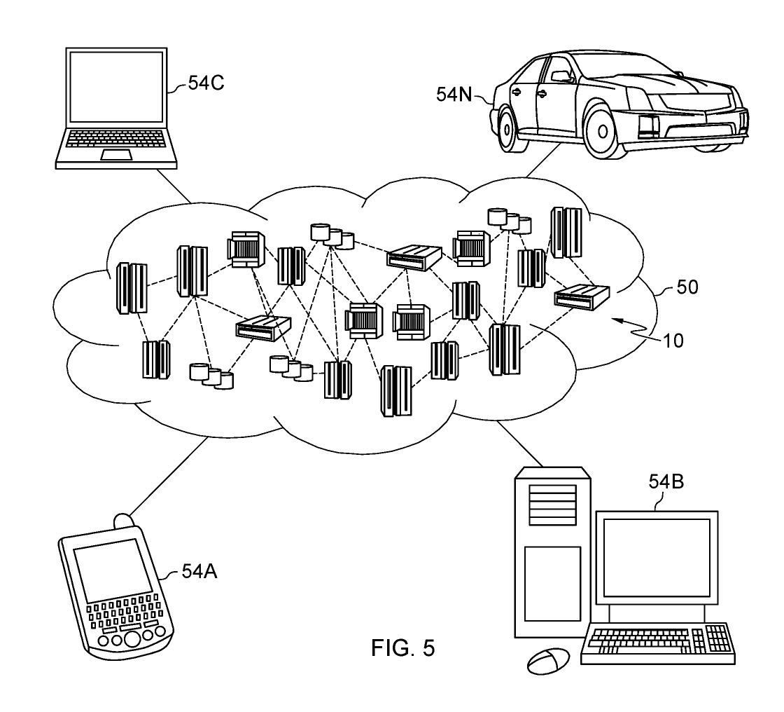

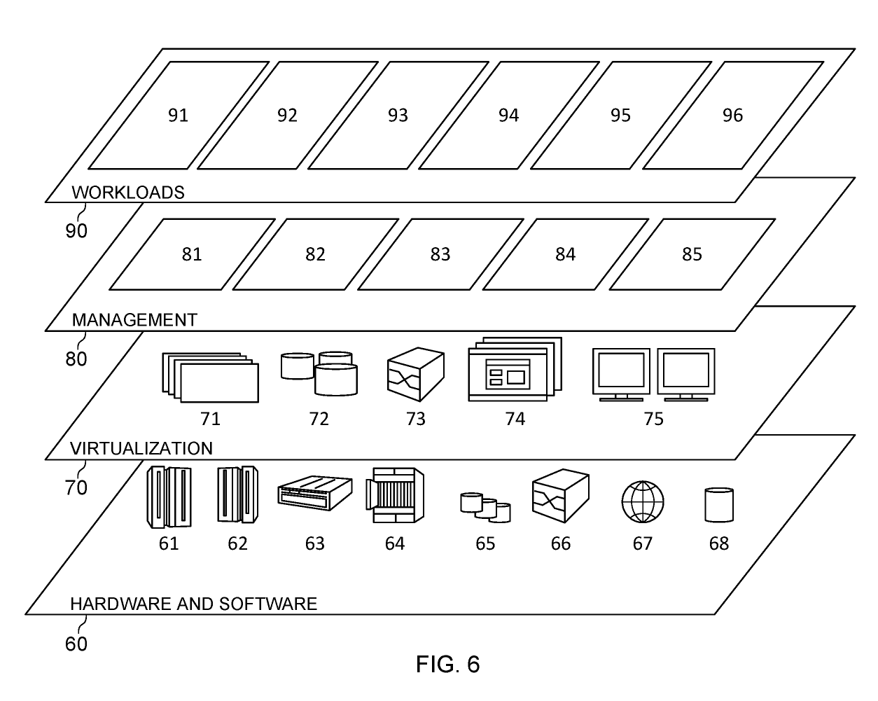

The user computing device 120 may be any type of computing devices that are capable of connecting to network 110, for example, a laptop computer, tablet computer, netbook computer, personal computer (PC), a desktop computer, a smart phone, or any programmable electronic device supporting the functionality required by one or more embodiments of the invention. The user computing device 120 may include internal and external hardware components, as described in further detail below with respect to FIG. 4. In other embodiments, the user computing device 120 may operate in a cloud computing environment, as described in further detail below with respect to FIGS. 5 and 6.

The first server 130, the second server 140, and the third server 150 comprise the same functional components, in accordance with an embodiment of the present invention. The present invention is able to be practice by one or more servers and for simplicity the invention is describe using multiple servers 130, 140, and 150. The first server 130, the second server 140, and the third server 150 deploy and manage complex workloads using virtual machines. The first server 130, the second server 140, and the third server 150 includes a profiler module 132, 142, 152, a compute instance module 136, 146, 156, and a workload module 138, 148, and 158.

The workload module 138, 148, and 158 receives a workload 200 to be processed and determines what type of compute instances (i.e. type of architecture of the compute instance) that are needed to process the workload. A compute instance is an instance of computer system spawned from a server. A compute instance can be a virtual machine, an emulation of a particular computer system, a container, or a lightweight operating-system-level virtual server.

The compute instance module 136, 146, and 156 generates compute instance that are needed to process the workload, such as, a virtual machine or a container. The virtual machines operate based on the computer architecture and functions of a real or hypothetical computer, and their implementations may involve specialized hardware, software, or a combination of both. The compute instance module 136, 146, and 156 can generate compute instance having a different architecture, the same architecture, or any combinations of architecture needed to process the workload 200. The compute instance module 136, 146, and 156 generates the compute instance of a specific architecture based the placement criteria.

The profiler module 132, 142, and 152 is a computer software agent, which constantly monitors/measures and reports the utilization of resources, by each of the deployed compute instances running the workload 200. The profiler module 132, 142, and 152 includes a placement criteria module 133, 143, and 153, and a growth module 134, 144, and 145.

The profiler modules 132, 142, and 152 monitors workload demand for the running workload 200. The placement criteria module 133, 143, and 153, allows for the creation and execution of placement criteria. The placement criteria refers to the set of rules/information that ultimately get fed into the overall system for deploying compute instance for processing a workload 100, and drives its decision process as to where (for example, as in specifically which virtual machines) each software component, from the complex workload specified, should be deployed and ran (i.e. placed). The placement criteria module 133, 143, and 153 determines the fields of the placement criteria. The fields are types of criteria that can be specified in the description file syntax for each workload, and where to place the compute instance to process the workload 200. The fields can correspond to traditional criteria, such as amount of CPU, Memory and disk space required, as well as the considered other criteria, such as Public or Private cloud domains, and specific hardware features (CPU architecture, virtual machine architecture, availability of certain accelerators, availability of memory bandwidth controllers and etc.). The placement criteria module 133, 143, and 153 determines the specific placement criteria that is associated with each of the architecture of the compute instances, for example, the virtual machines 210, 220, and 230 that are deployed to process workload 200.

The profiler module 132, 142, and 152 monitors the demand for the compute instance, for example, the virtual machines 210, 220, and 230 to process the workload and determines the growth of the virtual machines 210, 220 and 230 based on the growth settings set in the placement criteria. The growth module 134, 144, and 154 sets the growth rules that are set within the placement criteria.

The growth module 134, 144, and 154 generates a growth rule to be placed in the description in the compute instance that are used to process the workload 200. The growth module 134, 144, and 154 set the growth rules that cause the compute instance module 136, 146, and 156 to automatically add (increase) or remove (decrease) the number of compute instance based on the demand for the workload 200.

The profiler module 132, 142, and 152 monitors the workload 200 demand and determines if the number of compute instances, for example, virtual machines 210, 220, and 230 should grow (increase) or shrink (decrease). The profiler module 132, 142, and 152 determines a percentage of resources being actually utilized, when compared to the actual amount of resources assigned (i.e. made available) to the workload 200. Since the amount of resources utilized by each workload 200 is constantly being monitored by the profiler module 132, 142, and 152, it can determine when the overall utilization reaches a predetermined threshold. The profiler module 132, 142, and 152 can decide either to grow (increase) the available resources vertically (i.e. adding more compute instance from the same computer infrastructure the workload 200 is running on), or horizontally (by creating a copy of the workload on some other available compute node). Likewise, when the workload 200 utilization falls below a predetermined consolidation threshold, the number of resources (i.e. the number of compute instances, for example, the virtual machines 210, 220, and 230) are decreased from the workload 200. In either the growth or shrink (decrease) cases, the additional/removal of resources (virtual machines 210, 220, and 230) are also governed by the placement criteria specified for the workload 200.

Once the predetermined growth and consolidation thresholds are specified in the workload 200 description, the profiler module 132, 142, and 152 will constantly monitor the resource utilization rates, per workload 200, and depending on the predetermined growth and consolidation thresholds, the compute instance module 136, 146, and 156 will automatically grow (increase) or reduce (decrease) the amount of resources made available to the workload 200, either horizontally or vertically, depending on the available resources as well as depending on the placement criteria/rules. The predetermined growth and consolidation threshold corresponds to the overall resource utilization (i.e. load) of workload 200, at any given time.

The profiler module 132, 142, and 152 compares a percentage number that is obtained from the ratio between the actual resources being utilized and the overall resources assigned (i.e. made available) to the workload 200 to the predetermined growth and consolidation thresholds.

The profiler modules 132, 142 and 152 allow for pluggable software modules (not shown), that can be created for specific predictive event monitoring purposes. Each of the software modules can have a specific monitoring function (such as social media trends, or usage pattern detection, or network traffic increase detection . . . ) and can offer configuration attributes/parameters that can then be specified in the workload 200 description. In the workload 200 description, it can then specify the association between the event monitor, its configuration parameters and a workload growth rate. Grow rate, in this context, means a factor by which the workload 200 capacity can be expanded (i.e. by means of adding more resources to the workload 200), upon the trigger event being detected.

Once the internal logic in the event monitor detects the desired condition, it sends a signal back to the first server 130, the second server 140, and the third server 150, which in turn will notify the cloud scheduler to expand the referred workload 200 as specified in its workload description (growth rate).

This is typically event specific, but in general terms, the interface between the first server 130, the second server 140, and the third server 150 and the event prediction monitoring software allows the monitoring software to explicitly send a “trigger signal”, upon a desired (programmed) internal condition being reach. Although the framework allows for such pluggable event monitoring modules, the invention proposes at least three of these event prediction modules. Social media trends, which is a module that can be configured to monitor specified social media venues, looking for any desired term and use a typical search ranking/popularity algorithm. Upon the desired term reaching a certain rank (which is also a parameter), the module dispatches the growth trigger signal, back to the first server 130, the second server 140, and the third server 150. Usage pattern detection, in which the profiler module 132, 142, and 152 that can be configured to monitor workload 200 resource utilization increase, over time. If the resource utilization grows over a certain amount (specified as a parameter), over time, the profiler module 132, 142, and 152 dispatches the growth trigger signal to the compute instance module 136, 146, and 156. Network traffic increase detection, in which the profiler module 132, 142, and 152 monitors the amount of time, in-between incoming network connection requests. If this interval time becomes less than a certain amount (specified as parameter), the profiler module 132, 142, and 152 dispatches the growth trigger signal to the compute instance module 136, 146, and 156.

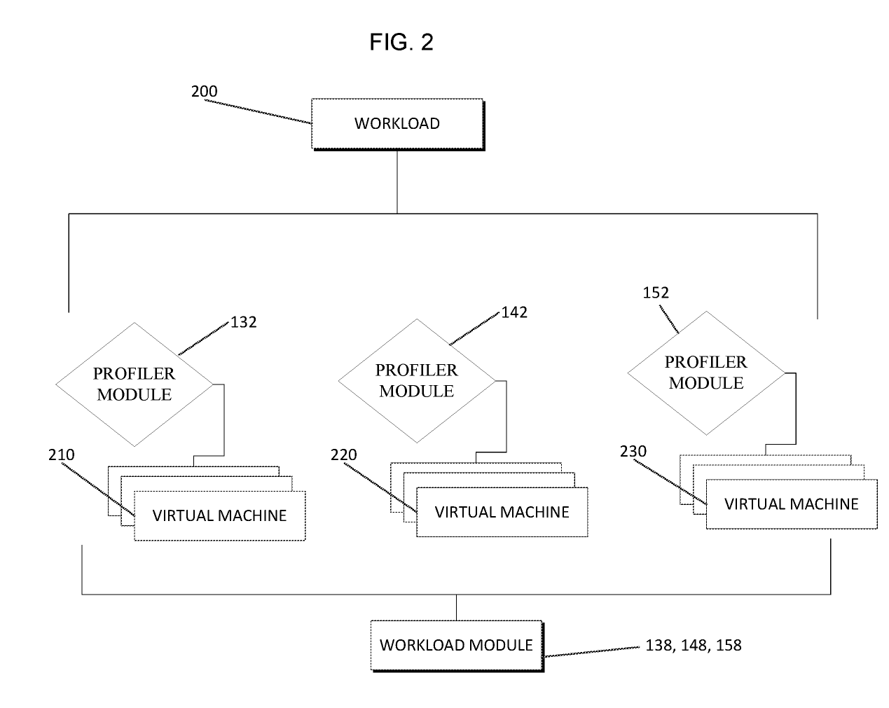

FIG. 2 illustrates the deployed compute instances, in accordance with an embodiment of the present invention.

Workload 200 is an application, program, job or any type of project that can be carried out by the compute instances, for example, the virtual machines 210, 220, and 230. The workload module 138, 148, and 158 determine the type of architecture that is required for compute instance, for example, the virtual machines 210, 220, and 230 that is necessary to process the workload 200. The profiler module 132, 142, and 152 monitor the virtual machines 210, 220, and 230, respectively, to maintain an optimum use of resources. The profiler module 132, 142, and 152 may either grow the number of compute instance (i.e. add virtual machines) or shrink the number of compute instance (i.e. removal of some of the virtual machines) based on the workload 200 demand and/or growth rules for the virtual machines 210, 220, and 230.

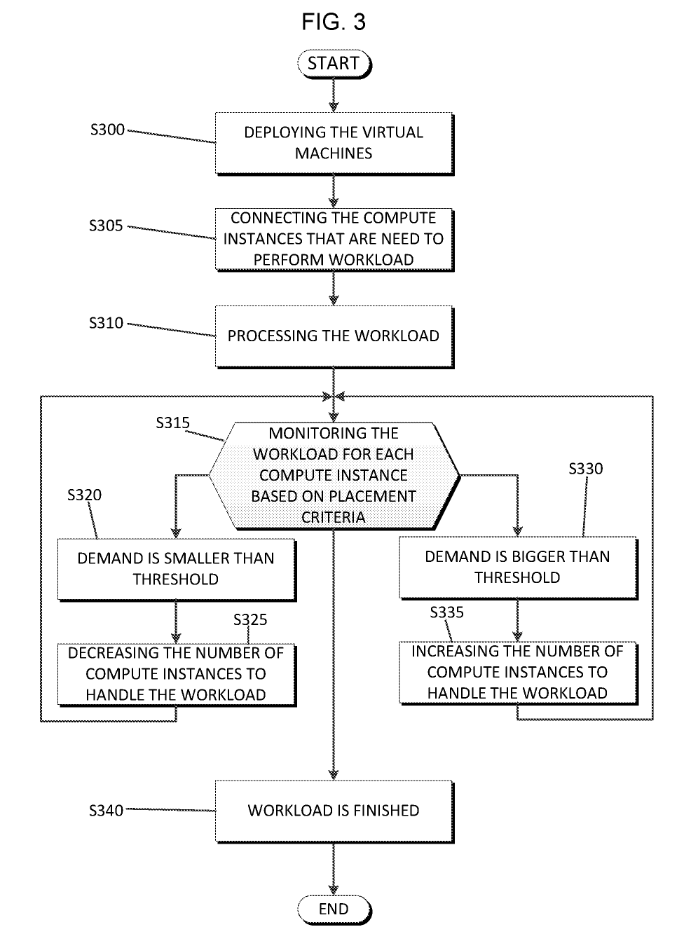

FIG. 3 is a flowchart depicting operational steps of deploying and monitoring the compute instances within the system for deploying compute instances of FIG. 1, in accordance with an embodiment of the present invention.

The first server 130, the second server 140, and/or the third server 150 receive a workload 200 to be processed. The placement criteria module 133, 143, and 153 determines what placement criteria that are needed and the growth module 134, 144, and 154 determines the growth rules associated with the compute instance, for example, virtual machines 210, 220, and/or 230. The compute instance module 136, 146, and 156 deploy the compute instance, for example, the virtual machines 210, 220, and/or 230, in accordance to the placement criteria and the growth rules (S300). The architecture of the deployed virtual machines 210, 220, and/or 230 can be all be the same, the architecture for one or more of the virtual machines 210, 220, and/or 230 can be different, or the architecture for all or the virtual machines 210, 220, and 230 are different from each other. The workload module 138, 148, and 158 connect the virtual machines 210, 220, and 230 that are necessary to process the workload 200 (S305). The virtual machines 210, 220, and 230 process the workload (S310).

The profiler module 132, 142, and 152 monitors the demand for the compute instances, for example, the virtual machines 210, 220, 230 to process the workload 200 (S315). The profiler module 132, 142, and 152 determines if the demand to process the workload 200 is below a threshold value (S320) and in response to the low demand the profiler module 132, 142, and 152 communicates with the compute instance module 136, 146, and 156 to automatically reduce the number of compute instance, for example, virtual machines 210, 220, and 230 assigned to process the workload 200 (S325). The profiler module 132, 142, and 152 constantly monitors the demand for the workload 200 (S315) to determine if virtual machines 210, 220, 230 are needed to automatically added or removed.

The profiler module 132, 142, and 152 monitors the demand for the virtual machines 210, 220, 230 to process the workload 200 (S315). The profiler module 132, 142, and 152 determines if the demand to process the workload 200 is above a threshold value (S330) and in response to the high demand the profiler module 132, 142, and 152 communicates with the compute instance module 136, 146, and 156 to automatically increase the number of compute instances, for example, increasing the number of virtual machines 210, 220, and 230 assigned to process the workload 200 (S335). The profiler module 132, 142, and 152 constantly monitors the demand for the workload 200 (S315) to determine if virtual machines 210, 220, 230 are needed to automatically added or removed.

The profiler module 132, 142, and 152 constantly monitors the demand for the workload 200 (S315) until there is no longer any demand for the workload 200. In response to the lack of demand for the workload 200, the workload module 138, 148, and 158 determines that the workload 200 is done being processed (S340).

FIG. 4 depicts a block diagram of components of user computing device 120, the first server 130, the second server 140, and the third server 150 of the system for deploying compute instance for processing a workload 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

The user computing device 120, the first server 130, the second server 140, and the third server 150 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, program to deploy virtual machines that includes the profiler modules 132, 142, and 152, the compute instance module 136, 146, and 156, and the workload module 138, 148, and 158 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The user computing device 120, the first server 130, the second server 140, and the third server 150 may also include a R/W drive or interface 914 to read from and write to one or more portable computer readable storage media 926. Application programs 911 on the user computing device 120, the first server 130, the second server 140, and the third server 150 may be stored on one or more of the portable computer readable storage media 926, read via the respective R/W drive or interface 914 and loaded into the respective computer readable storage media 908.

The user computing device 120, the first server 130, the second server 140, and the third server 150 may also include a network adapter or interface 916, such as a TCP/IP adapter card or wireless communication adapter (such as a 4G wireless communication adapter using OFDMA technology). Application programs 911 on the user computing device 120, the first server 130, the second server 140, and the third server 150 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The user computing device 120, the first server 130, the second server 140, and the third server 150 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a system for deploying compute instance for processing a workload 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method for a system for deploying compute instances for processing a workload, the method comprising:
receiving, by a computer, a workload to be processed;
determining, by the computer, an architecture for a compute instance that is required to process the workload, wherein the compute instance is an instance of computer system being spawned from a computing device;
setting, by the computer, growth rules for the compute instance, wherein the growth rules determines when the number of compute instances needs to be increased or decreased;
deploying, by the computer, the compute instance to process the workload;
monitoring, by the computer, a demand for the deployed compute instance to process the workload; and
automatically increasing or decreasing, using the computer, the number of deployed compute instances, based on the monitored demand for the deployed compute instances and the growth rules for the compute instances.

2. The method of claim 1, wherein deploying the compute instance requires that a plurality of compute instances be deployed to process the workload.

3. The method of claim 2, wherein at least one of the deployed compute instances of the plurality of deployed compute instances has a first architecture and at least one of the deployed compute instances of the plurality of deployed compute instances has a second architecture, wherein the first architecture is different than the second architecture.

4. The method of claim 3, wherein the automatically increasing or decreasing, using the computer, the number of deployed compute instances, based on the monitored demand for the deployed compute instances comprises:
increasing the number of deployed compute instances when demand for the workload is greater than or equal to a first threshold value; or
decreasing the number of deployed compute instances when demand for the workload is less than or equal to a second threshold value.

5. The method of claim 1, wherein automatically increasing or decreasing, using the computer, the number of deployed compute instances, based on the monitored demand for the deployed compute instances comprises:
increasing the number of deployed compute instances when demand for the workload is greater than or equal to a first threshold value; or
decreasing the number of deployed compute instances when demand for the workload is less than or equal to a second threshold value.

6. The method of claim 5, wherein the demand is determined by comparing a percentage number that is obtained from the ratio between actual resources being utilized by the compute instance and an overall resources available to the workload.

7. The method of claim 5, wherein the monitoring, by the computer, the demand for the deployed compute instance to process the workload, comprises;
monitoring, by the computer, the workload resource utilization; and
monitoring, by the computer, a network traffic, such that, monitoring an in-between incoming network connection requests.

8. The method of claim 5, wherein deploying the compute instance requires that a plurality of compute instances be deployed to process the workload; and wherein at least one of the deployed compute instances of the plurality of deployed compute instances has a first architecture and at least one of the deployed compute instances of the plurality of deployed compute instances has a second architecture, wherein the first architecture is different than the second architecture.

9. A computer program product for deploying compute instances for processing a workload, the computer program product comprising:
one or more non-transitory computer-readable storage media and program instructions stored on the one or more non-transitory computer-readable storage media, the program instructions comprising:
receiving a workload to be processed;
determining an architecture for a compute instance that is required to process the workload, wherein the compute instance is an instance of computer system being spawned from a computing device;
setting growth rules for the compute instance, wherein the growth rules determines when the number of compute instances needs to be increased or decreased;
deploying the compute instance to process the workload;
monitoring a demand for the deployed compute instance to process the workload; and
automatically increasing or decreasing the number of deployed compute instances, based on the monitored demand for the deployed compute instances and the growth rules for the compute instances.

10. The computer program product of claim 9, wherein deploying the compute instance requires that a plurality of compute instances be deployed to process the workload.

11. The computer program product of claim 10, wherein at least one of the deployed compute instances of the plurality of deployed compute instances has a first architecture and at least one of the deployed compute instances of the plurality of deployed compute instances has a second architecture, wherein the first architecture is different than the second architecture.

12. The computer program product of claim 11, wherein the automatically increasing or decreasing the number of deployed compute instances, based on the monitored demand for the deployed compute instances comprises:
increasing the number of deployed compute instances when demand for the workload is greater than or equal to a first threshold value; or
decreasing the number of deployed compute instances when demand for the workload is less than or equal to a second threshold value.

13. The computer program product of claim 9, wherein the automatically increasing or decreasing the number of deployed compute instances, based on the monitored demand for the deployed compute instances comprises:
increasing the number of deployed compute instances when demand for the workload is greater than or equal to a first threshold value; or decreasing the number of deployed compute instances when demand for the workload is less than or equal to a second threshold value.

14. The computer program product of claim 13, wherein the demand is determined by comparing a percentage number that is obtained from the ratio between actual resources being utilized by the compute instance and an overall resources available to the workload.

15. The computer program product of claim 13, wherein the monitoring, by the computer, the demand for the deployed compute instance to process the workload, comprises;
monitoring the workload resource utilization; and
monitoring a network traffic, such that, monitoring an in-between incoming network connection requests.

16. The computer program product of claim 13, wherein deploying the compute instance requires that a plurality of compute instances be deployed to process the workload; and wherein at least one of the deployed compute instances of the plurality of deployed compute instances has a first architecture and at least one of the deployed compute instances of the plurality of deployed compute instances has a second architecture, wherein the first architecture is different than the second architecture.

17. A computer system for deploying virtual machines for processing a workload, the computer system comprising:
one or more computer processors, one or more computer-readable storage media, and program instructions stored on one or more of the computer-readable storage media for execution by at least one of the one or more processors, the program instructions comprising:
receiving a workload to be processed;
determining an architecture for a compute instance that is required to process the workload, wherein the compute instance is an instance of computer system being spawned from a computing device;
setting growth rules for the compute instance, wherein the growth rules determines when the number of compute instances needs to be increased or decreased;
deploying the compute instance to process the workload;
monitoring a demand for the deployed compute instance to process the workload; and
automatically increasing or decreasing the number of deployed compute instances, based on the monitored demand for the deployed compute instances and the growth rules for the compute instances.

18. The computer system of claim 17, wherein the automatically increasing or decreasing the number of deployed compute instances, based on the monitored demand for the deployed compute instances comprises:
increasing the number of deployed compute instances when demand for the workload is greater than or equal to a first threshold value; or
decreasing the number of deployed compute instances when demand for the workload is less than or equal to a second threshold value.

19. The computer system of claim 17, wherein the monitoring, by the computer, the demand for the deployed compute instance to process the workload, comprises;
monitoring the workload resource utilization; and
monitoring a network traffic, such that, monitoring an in-between incoming network connection requests.

20. The computer system of claim 17, wherein deploying the compute instance requires that a plurality of compute instances be deployed to process the workload; and wherein at least one of the deployed compute instances of the plurality of deployed compute instances has a first architecture and at least one of the deployed compute instances of the plurality of deployed compute instances has a second architecture, wherein the first architecture is different than the second architecture.
